(19) United States
(12) Patent Application Publication
(10) Pub. No.: US 2024/0353001 A1
(43) Pub. Date: Oct. 24, 2024

(54) WORKING VEHICLE

(71) Applicant: KUBOTA CORPORATION, Osaka (JP)

(72) Inventor: Ryosuke TANAKA, Sakai-shi (JP)

(21) Appl. No.: 18/640,043

(22) Filed: Apr. 19, 2024

(30) Foreign Application Priority Data
Apr. 24, 2023 (JP) 2023-070931

(51) Int. Cl. F16H 59/06; F16H 59/02

(52) U.S. Cl. CPC F16H 59/06; F16H 2059/0234

(57) ABSTRACT

A neutral biasing mechanism in a working vehicle includes a cam connected to an operating shaft of a continuously variable transmission and provided with a concave cam section, an operator swingable about an axis of a swing shaft and configured to operate the cam to a neutral orientation by pressing the cam section, and biasing members configured to bias the operator such that the operator swings in a direction in which the operator presses the cam section. Some of the biasing members are connected to a first connection point that is in the operator, and the other biasing members are connected to a second connection point that is in the operator and is different from the first connection point.

### CROSS REFERENCE TO RELATED APPLICATIONS

This application claims the benefit of priority to Japanese Patent Application No. 2023-070931 filed on Apr. 24, 2023. The entire contents of this application are hereby incorporated herein by reference.

### BACKGROUND OF THE INVENTION

### 1. Field of the Invention

The present invention relates to working vehicles each including a continuously variable transmission capable of shifting to a forward side and a reverse side, and also relates to neutral biasing mechanisms each configured to bias a continuously variable transmission to a neutral position.

### 2. Description of the Related Art

Examples of conventional working vehicles include those including a neutral biasing mechanism configured to bias a trunnion shaft of a continuously variable transmission to a neutral position as described in JP 2016-065636A.

However, in conventional working vehicles, a biasing force is applied by one biasing member (a “biasing spring” in JP 2016-065636A) located at one point in a neutral biasing mechanism.

With this configuration, a biasing force is applied by one biasing member located at one point, and thus there is room for improvement in terms of adjusting the biasing force such as reducing the difference in spring load between the beginning and maximum depression of the speed change pedal, for example.

### SUMMARY OF THE INVENTION

Example embodiments of the present invention provide working vehicles in each of which a biasing force of a neutral biasing mechanism configured to bias a continuously variable transmission to a neutral position can be easily adjusted.

According to an example embodiment of the present invention, a working vehicle includes a continuously variable transmission capable of shifting to a forward side and a reverse side, and a neutral biasing mechanism configured to bias the continuously variable transmission to a neutral position, wherein the neutral biasing mechanism includes a cam connected to an operating shaft of the continuously variable transmission and provided with a concave cam section, an operator swingable about an axis of a swing shaft and configured to operate the cam to a neutral orientation corresponding to the neutral position by pressing the cam section, and a plurality of biasing members configured to bias the operator such that the operator swings in a direction in which the operator presses the cam section, and some of the plurality of biasing members are connected to a first connection point that is in the operator, and remaining ones of the biasing members are connected to a second connection point that is in the operator and is different from the first connection point.

According to an example embodiment of the present invention, biasing members are respectively connected to two points in the neutral biasing mechanism, and thus it is possible to combine biasing forces and action points of the biasing members. This makes it possible to easily adjust the biasing force of the neutral biasing mechanism.

In an example embodiment of the present invention, it is preferable that the first connection point is in a portion on one side in the operator with respect to the swing shaft, and the second connection point is in a portion on another side in the operator with respect to the swing shaft.

According to this configuration, the points to which the biasing members are respectively connected in the neutral biasing mechanism are spaced by a certain distance from each other, and thus it is possible to distribute the load on the members of the neutral biasing mechanism. This makes it possible to construct a more durable mechanism.

In an example embodiment of the present invention, it is preferable that a line of action of a biasing force of the biasing members connected to the first connection point is not parallel to that of the biasing members connected to the second connection point.

According to this configuration, it is possible to more suitably adjust the biasing force of the neutral biasing mechanism by combining attachment angles in addition to the biasing forces and action points of the biasing members.

In an example embodiment of the present invention, it is preferable that the operator includes a rotatable roller configured to operate the cam to the neutral orientation corresponding to the neutral position by fitting into the cam section.

According to this configuration, a rotatable roller fits into the cam section while the cam is being operated to the neutral orientation. Since the smoothly operating roller fits into the cam section, it is possible to smoothly operate the neutral biasing mechanism.

In an example embodiment of the present invention, it is preferable that a distance from the first connection point to the axis of the swing shaft is different from that from the second connection point to the axis of the swing shaft.

According to this configuration, it is possible to more suitably adjust the biasing force of the neutral biasing mechanism by combining distances to the axis of the swing shaft in addition to the biasing forces and action points of the biasing members.

In an example embodiment of the present invention, it is preferable that the biasing members consist of two biasing members, the operator includes a first operator and a second operator configured to swing as one piece with the first operator, and the two biasing members include a first biasing member connected to the first operator and a second biasing member connected to the second operator.

According to this configuration, a biasing member is connected to each of the first operator and the second operator, and thus it is possible to distribute the load on the operator, which it makes possible to construct a more durable mechanism.

In an example embodiment of the present invention, it is preferable that a transmission case is provided behind the continuously variable transmission, and the second biasing member extends between the second operator and the transmission case.

According to this configuration, it is possible to suitably set the attachment position of the biasing member with use of the transmission case.

In an example embodiment of the present invention, it is preferable that the first biasing member and the second biasing member include coil springs with respective different lengths.

According to this configuration, it is possible to more suitably adjust the biasing force of the neutral biasing mechanism by combining lengths of the coil springs in addition to the biasing forces and the action points of the coil springs.

In an example embodiment of the present invention, it is preferable that the first biasing member and the second biasing member include coil springs with respective different diameters.

According to this configuration, it is possible to more suitably adjust the biasing force of the neutral biasing mechanism by combining diameters of the coil springs in addition to the biasing forces and the action points of the coil springs.

The above other and elements, features, steps, characteristics and advantages of the present invention will become more apparent from the following detailed description of the example embodiments with reference to the attached drawings.

### BRIEF DESCRIPTION OF THE DRAWINGS

FIG. 1 is a right side view of a tractor.

FIG. 2 is a plan view of the tractor.

FIG. 3 is a right side view showing a speed change operation mechanism at a neutral position and a neutral biasing mechanism.

FIG. 4 is a right side view showing the speed change operation mechanism at a forward maximum speed position and the neutral biasing mechanism.

FIG. 5 is a right side view showing the speed change operation mechanism at a reverse maximum speed position and the neutral biasing mechanism.

FIG. 6 is a right side view showing the speed change operation mechanism in an interlocked state and an interlocked state switching mechanism.

FIG. 7 is a right side view showing the speed change operation mechanism in a non-interlocked state and the interlocked state switching mechanism.

### DETAILED DESCRIPTION OF THE EXAMPLE EMBODIMENTS

Example embodiments of the present invention will be described with reference to the drawings. In the following description, the arrow F shown in the drawings indicates the “forward direction”, the arrow B indicates the “backward direction”, the arrow L indicates the “leftward direction”, and the arrow R indicates the “rightward direction”, unless otherwise described. The arrow U shown in the drawings indicates the “upward direction”, and the arrow D indicates the “downward direction”.

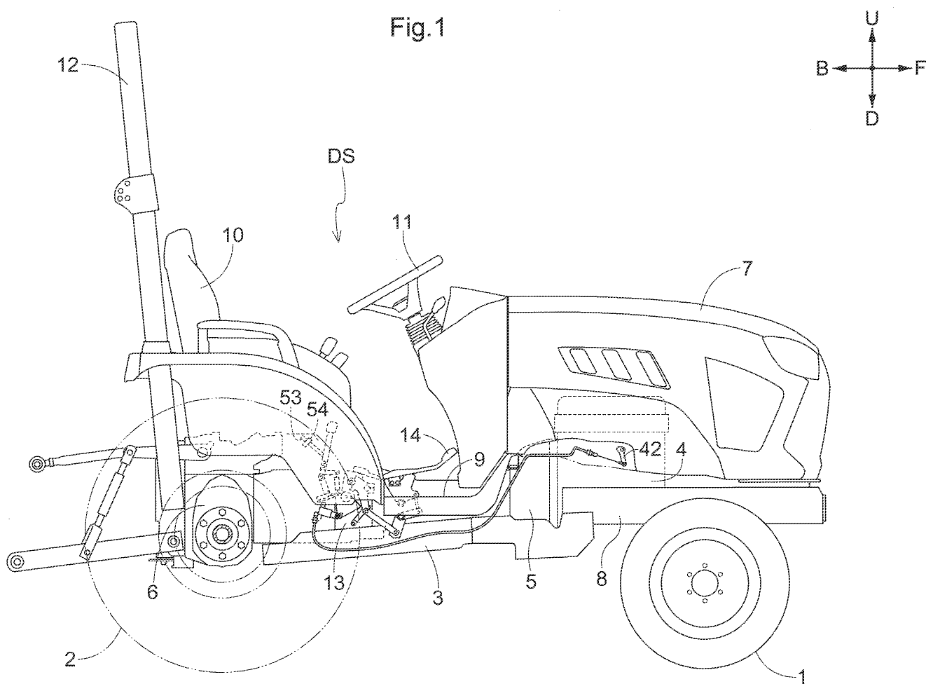

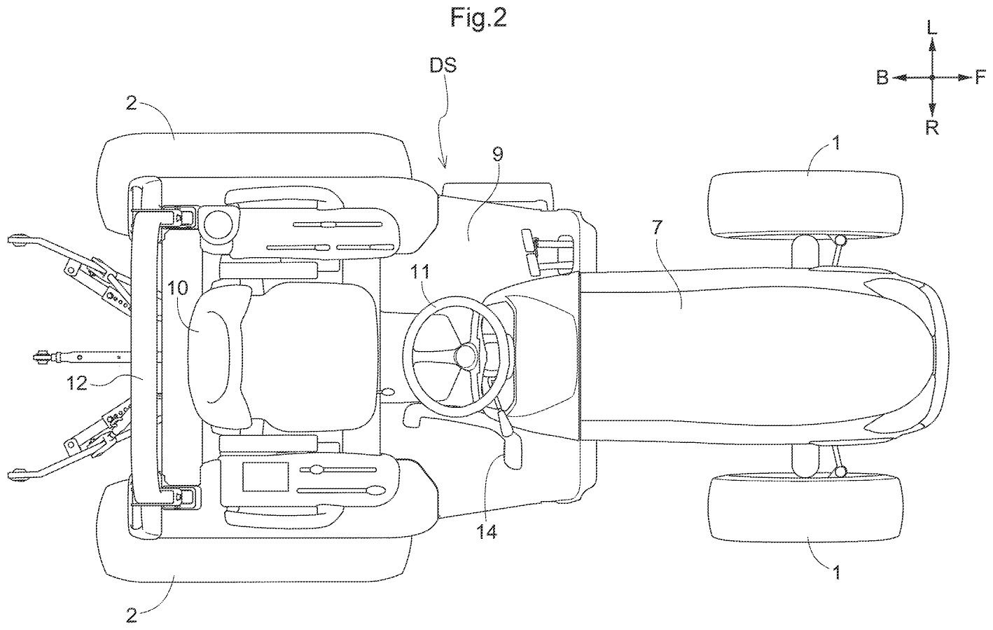

A tractor shown in FIGS. 1 and 2 includes steerable and drivable left and right front wheels 1, drivable left and right rear wheels 2, and left and right body frames 3 on the front wheels 1 and the rear wheels 2.

The body frames 3 support an engine 4, a clutch housing 5 coupled to the rear portion of the engine 4, and a transmission case 6 coupled to the rear portion of the clutch housing 5 and including an internal portion in which a gear-type transmission (not shown) configured to function as an auxiliary transmission and the like are accommodated.

A front frame 8 extends forward from the lower portion of the engine 4. A hood 7 configured to cover the engine 4 is above the front frame 8.

A driver's station DS is behind the hood 7. A floor 9 is at the lower portion of the driver's station DS, and a driver's seat 10 on which the driver sits and a steering wheel 11 with which the front wheels 1 can be steered are above the floor 9. An inverted U-shaped lops frame 12 is behind the driver's seat 10.

A hydrostatic continuously variable transmission 13 configured to function as a main transmission is below the driver's station DS. Motive power of the engine 4 is transmitted from a clutch (not shown) inside the clutch housing 5 via a transmission shaft (not shown) to the continuously variable transmission 13.

Motive power whose speed has been changed by the continuously variable transmission 13 is transmitted via the auxiliary transmission and a rear wheel differential device (not shown) inside the transmission case 6 to the rear wheels 2. Motive power diverted from a point between the auxiliary transmission and the rear wheel differential device is transmitted from a front wheel transmission (not shown) inside the transmission case 6 via a transmission shaft (not shown) and a front wheel differential device (not shown) to the front wheels 1.

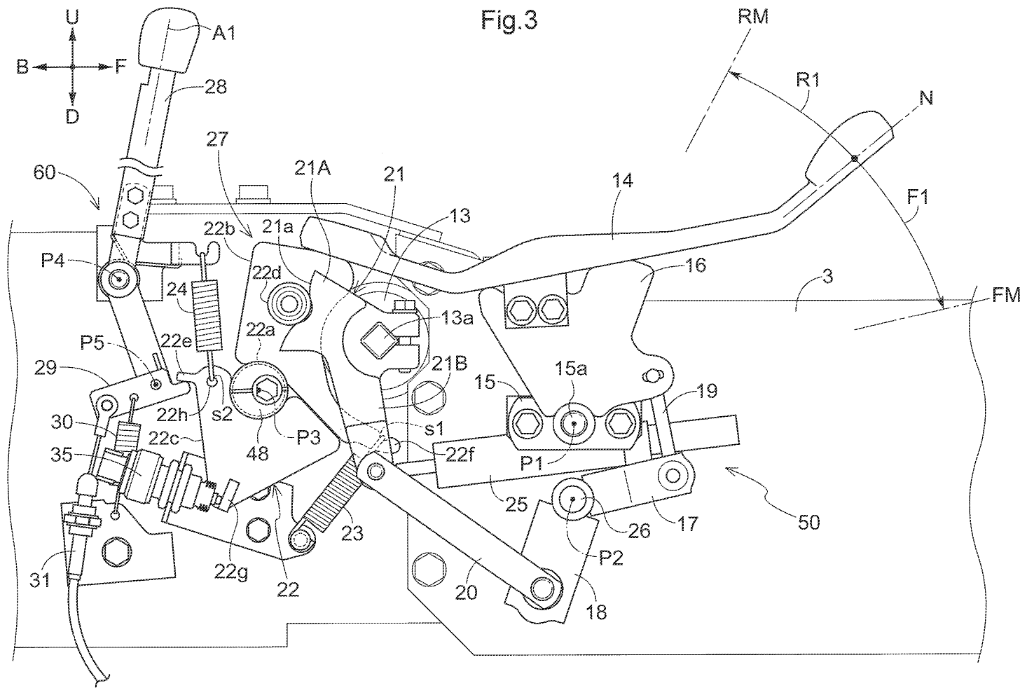

The continuously variable transmission 13 is capable of steplessly changing the motive power of the engine 4 to a forward side and a reverse side. As shown in FIGS. 3 to 5, the continuously variable transmission 13 is shifted by a speed change operation mechanism 50. The operation of the speed change operation mechanism 50 is transmitted via an interlocked state switching mechanism 60 to an accelerator unit 42 of the engine 4.

The speed change operation mechanism 50 is manually operated to shift the continuously variable transmission 13. The speed change operation mechanism 50 includes a manually operable speed change pedal 14, a support member 16 attached to a bracket 15 below the speed change pedal 14, a link arm 17 and a link arm 18 coupled to the body frames 3, a link rod 19 connected between the support member 16 and the link arm 17, a connecting member 20 and a cam 21 connected between the link arm 18 and a trunnion shaft 13a (an example of the “operating shaft”) of the continuously variable transmission 13, and the like.

The bracket 15 is fixed to the right body frame 3. The bracket 15 includes a fulcrum shaft 15a. The support member 16 is attached to the fulcrum shaft 15a of the bracket 15 so as to be swingable about an axis P1 that is along the left-right direction. The speed change pedal 14 is coupled to the upper portion of the support member 16. This configuration allows the floor 9 of the driver's station DS to be provided with the seesaw-type speed change pedal 14 that is swingable between a forward maximum speed position FM and a reverse maximum speed position RM.

A fulcrum shaft 26 is coupled to the right body frame 3. The link arm 17 and the link arm 18 are coupled to each other. The link arm 17 and the link arm 18 are attached to the fulcrum shaft 26 so as to be swingable as one piece about an axis P2 that is along the left-right direction. The link rod 19 extends between the support member 16 and the link arm 17.

The cam 21 is attached to the trunnion shaft 13a of the continuously variable transmission 13, and the connecting member 20 is connected between the lower portion of the link arm 18 and the cam 21. A shock absorber 25 is connected between the lower portion of the cam 21 and the right body frame 3 and is located in the front-rear direction between the bracket 15 and the fulcrum shaft 26. The shock absorber 25 reduces or prevents an abrupt operation of the speed change pedal 14 to a forward side F1 toward the forward maximum speed position FM and to a reverse side R1 toward the reverse maximum speed position RM.

A neutral biasing mechanism 27 is configured to apply a biasing force to rotatably operate the trunnion shaft 13a of the continuously variable transmission 13 such that the trunnion shaft 13a is in the neutral position shown in FIG. 3. The neutral biasing mechanism 27 includes an operator 22 configured to operate the cam 21 and a plurality of springs (an example of the “biasing members”). In this example embodiment, the cam 21 is also included in the configuration of the neutral biasing mechanism 27.

The cam 21 includes a fan-shaped fan section 21A and an operation arm 21B integrated with the fan section 21A.

The edge of the fan section 21A of the cam 21 includes a cam section 21a that is concave toward the trunnion shaft 13a. The base end of the fan section 21A is coupled to the trunnion shaft 13a by pinching the right end of the trunnion shaft 13a.

The operation arm 21B extends downward from the fan section 21A. The connecting member 20 of the speed change operation mechanism 50 is connected to the lower end of the operation arm 21B. A swing shaft 48 is on the right wall of the continuously variable transmission 13. The swing shaft 48 has an axis P3 that is parallel to the trunnion shaft 13a. The operator 22 is swingable about the axis P3 of the swing shaft 48.

The operator 22 includes a support member 22a, an upper member 22b (an example of the “first operator”), and a lower member 22c (an example of the “second operator”). The support member 22a has a cylindrical shape and is fitted to the swing shaft 48. The upper member 22b is fixed to the upper portion of the support member 22a. The lower member 22c is fixed to the lower portion of the support member 22a. This configuration allows the lower member 22c to swing as one piece with the upper member 22b.

The upper member 22b has a rotatable roller 22d. The roller 22d is in contact with the cam 21.

As shown in FIGS. 3 to 5, two coil springs consisting of a first spring 23 (an example of the “first biasing member”) and a second spring 24 (an example of the “second biasing member”) are included as the plurality of springs of the neutral biasing mechanism 27, for example. The first spring 23 and the second spring 24 are connected to the operator 22 in a slightly stretched state that is greater than a free length thereof, and are configured to bias the operator 22 such that the operator 22 swings in a direction in which it presses the cam section 21a.

Although not shown, in this example embodiment, the free length of the first spring 23 is different from that of the second spring 24, and the second spring 24 is longer than the first spring 23. The diameter (the winding diameter) of the first spring 23 is substantially the same as that of the second spring 24. The spring constant of the second spring 24 is larger than that of the first spring 23.

One end of the first spring 23 is connected to the front portion of the operator 22. The configuration is specifically as follows. The upper member 22b of the operator 22 includes an arm 22f extending forward and downward from a point that is in the upper member 22b and is in front of the swing shaft 48. That is to say, the arm 22f extends in a direction away from the swing shaft 48. The first spring 23 is connected to the front end of the arm 22f. In this example embodiment, a point that is in the operator 22 and to which the first spring 23 is connected is referred to as a “first connection point s1”.

The other end of the first spring 23 is connected to a stay 33 located behind and below the first connection point s1 and fixed to the right wall of the continuously variable transmission 13. This configuration allows the biasing force of the first spring 23 connected to the first connection point s1 to act rearward and downward from the first connection point s1.

One end of the second spring 24 is connected to the rear portion of the operator 22. The configuration is specifically as follows. The lower member 22c of the operator 22 has a hole 22h at a point that is in the lower member 22c and is behind the swing shaft 48. The second spring 24 is connected to the lower member 22c by being hooked to the hole 22h. In this example embodiment, a point that is in the operator 22 and to which the second spring 24 is connected is referred to as a “second connection point s2”.

With the configuration described above, the second spring 24 is connected to a point that is in the operator 22 and is different from the first connection point s1. The first connection point s1 is in a portion on one side in the operator 22 with respect to the swing shaft 48, and the second connection point s2 is in a portion on the other side in the operator 22 with respect to the swing shaft 48.

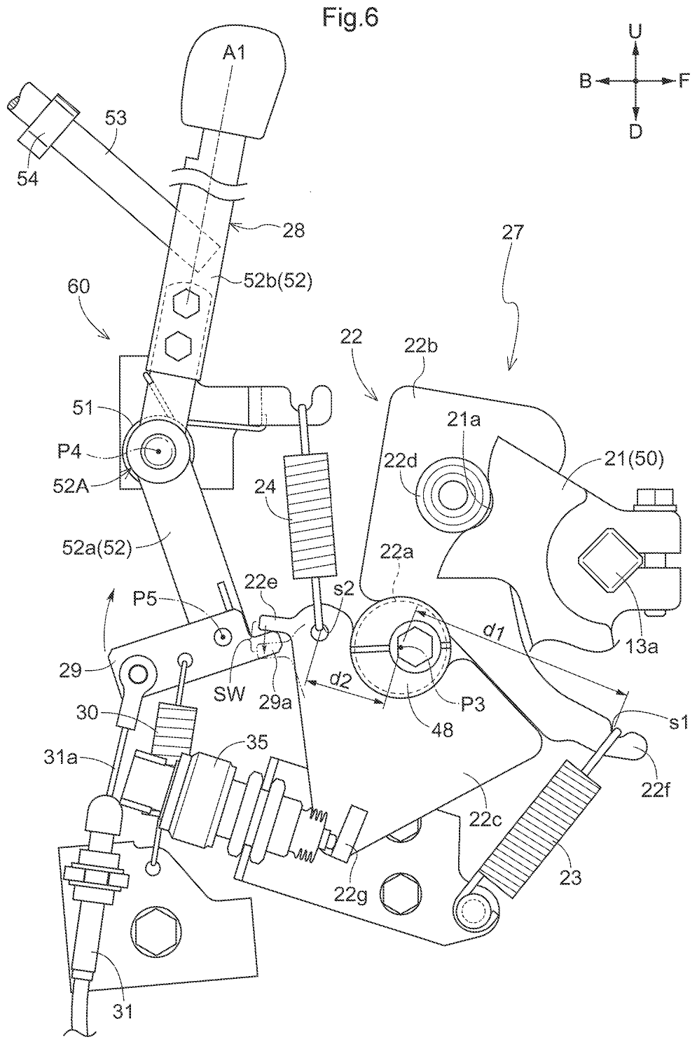

As shown in FIG. 6, a first distance d1 from the first connection point s1 to the axis P3 of the swing shaft 48 is different from a second distance d2 from the second connection point s2 to the axis P3 of the swing shaft 48, and the first distance d1 is longer than the second distance d2.

As shown in FIGS. 3 to 5, the other end of the second spring 24 is connected to a stay 34 located above the second connection point s2 and fixed to the right wall of the transmission case 6 behind the continuously variable transmission 13. That is to say, the second spring 24 extends between the lower member 22c and the transmission case 6. This configuration allows the biasing force of the second spring 24 connected to the second connection point s2 to act upward from the second connection point s2.

With the configuration described above, the line of action of the biasing force of the second spring 24 connected to the second connection point s2 extends upward from the second connection point s2. The line of action of the biasing force of the first spring 23 connected to the first connection point s1 extends from the first connection point s1 rearward and downward, that is, diagonally downward to the rear side. As a result, the line of action of the biasing force of the first spring 23 is not parallel to that of the second spring 24 connected to the second connection point s2.

FIG. 3 shows a state in which the speed change pedal 14 has been operated to a neutral position N corresponding to the neutral position of the trunnion shaft 13a of the continuously variable transmission 13.

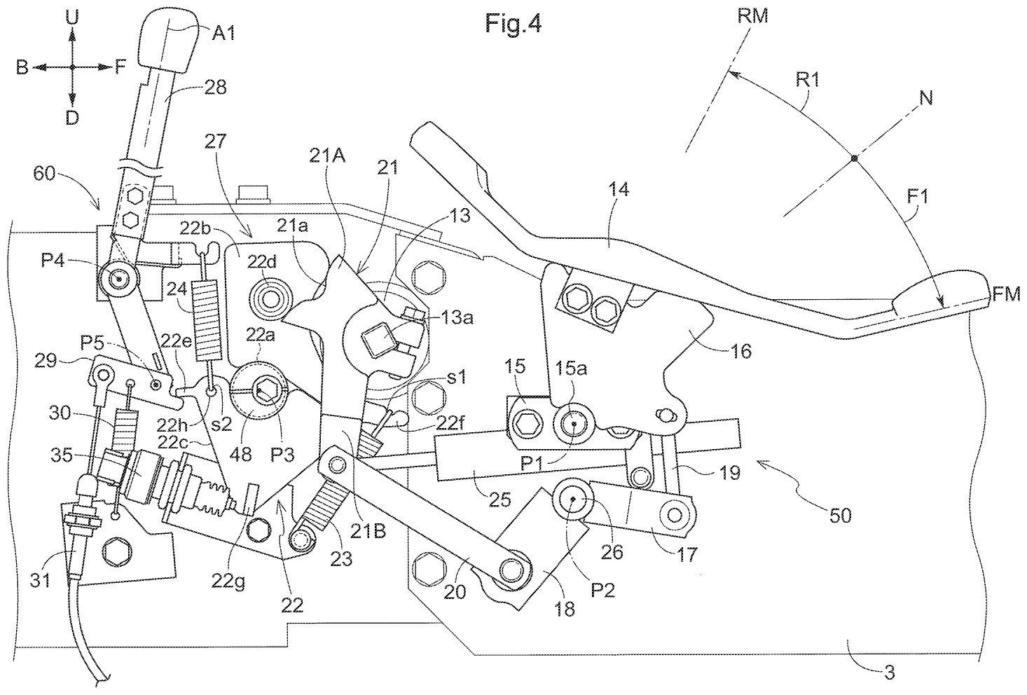

In order to operate the speed change pedal 14 to the forward and high speed side, a driver depresses the front portion of the speed change pedal 14 downward. FIG. 4 shows a state in which the speed change pedal 14 has been operated to the forward maximum speed position FM. In response to the speed change pedal 14 being operated from the neutral position N to the forward side F1, the link rod 19 depresses the front portion of the link arm 17 downward. Accordingly, the link arms 17 and 18 swing clockwise in FIGS. 3 and 4. The connecting member 20 connected to the link arm 18 causes the cam 21 to swing clockwise in FIGS. 3 and 4. As a result, the continuously variable transmission 13 is operated to the forward and high speed side.

In response to the cam 21 swinging clockwise in FIGS. 3 and 4, the lower portion of the cam section 21a presses the roller 22d. In response to the roller 22d being pressed, the operator 22 swings counterclockwise in FIGS. 3 and 4 about the axis P3 of the swing shaft 48 against the biasing force of the first spring 23 and the second spring 24.

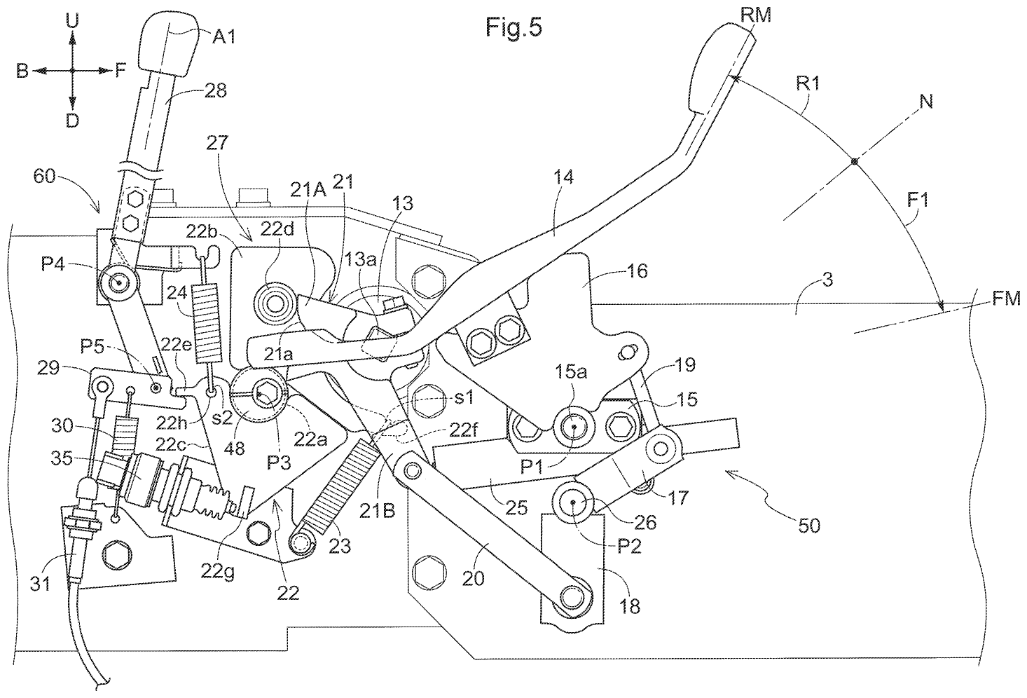

In order to operate the speed change pedal 14 to the reverse and high speed side, the driver depresses the rear portion of the speed change pedal 14 downward. FIG. 5 shows a state in which the speed change pedal 14 has been operated to the reverse maximum speed position RM. In response to the speed change pedal 14 being operated from the neutral position N to the reverse side R1, the link rod 19 pulls the front portion of the link arm 17 upward. Accordingly, the link arms 17 and 18 swing counterclockwise in FIGS. 3 and 5. The connecting member 20 connected to the link arm 18 causes the cam 21 to swing counterclockwise in FIGS. 3 and 5. As a result, the continuously variable transmission 13 is operated to the reverse and high speed side.

In response to the cam 21 swinging counterclockwise in FIGS. 3 and 5, the upper portion of the cam section 21a presses the roller 22d. In response to the roller 22d being pressed, the operator 22 swings counterclockwise in FIGS. 3 and 5 about the axis P3 of the swing shaft 48 against the biasing force of the first spring 23 and the second spring 24.

That is to say, in response to the continuously variable transmission 13 being shifted to either the forward side or the reverse side, the operator 22 swings counterclockwise in FIGS. 3 to 5 about the axis P3 of the swing shaft 48.

In response to the driver stopping depressing the speed change pedal 14, the operator 22 that has swung counterclockwise in FIGS. 3 to 5 swings clockwise in FIGS. 3 to 5 following the biasing force of the first spring 23 and the second spring 24. The roller 22d fits into the cam section 21a of the cam 21, and operates the cam 21 to the neutral orientation corresponding to the neutral position of the trunnion shaft 13a of the continuously variable transmission 13.

A limit switch type neutral detection sensor 35 is attached to the lower portion of the right side of the transmission case 6. In response to the speed change pedal 14 and the trunnion shaft 13a of the continuously variable transmission 13 being operated to the neutral position, a convex portion 22g of the lower member 22c comes into contact with the neutral detection sensor 35. Accordingly, the neutral detection sensor 35 detects that the trunnion shaft 13a of the continuously variable transmission 13 has been operated to the neutral position.

The operation of the speed change operation mechanism 50 is transmitted via the interlocked state switching mechanism 60 to the accelerator unit 42 of the engine 4. The interlocked state switching mechanism 60 switches the state between an interlocked state in which the accelerator unit 42 of the engine 4 (see FIG. 1) is operated to the high speed side in response to the speed change operation mechanism 50 operating the continuously variable transmission 13 to the high speed side and a non-interlocked state in which the accelerator unit 42 of the engine 4 is not operated in response to the speed change operation mechanism 50 operating the continuously variable transmission 13 to the high speed side.

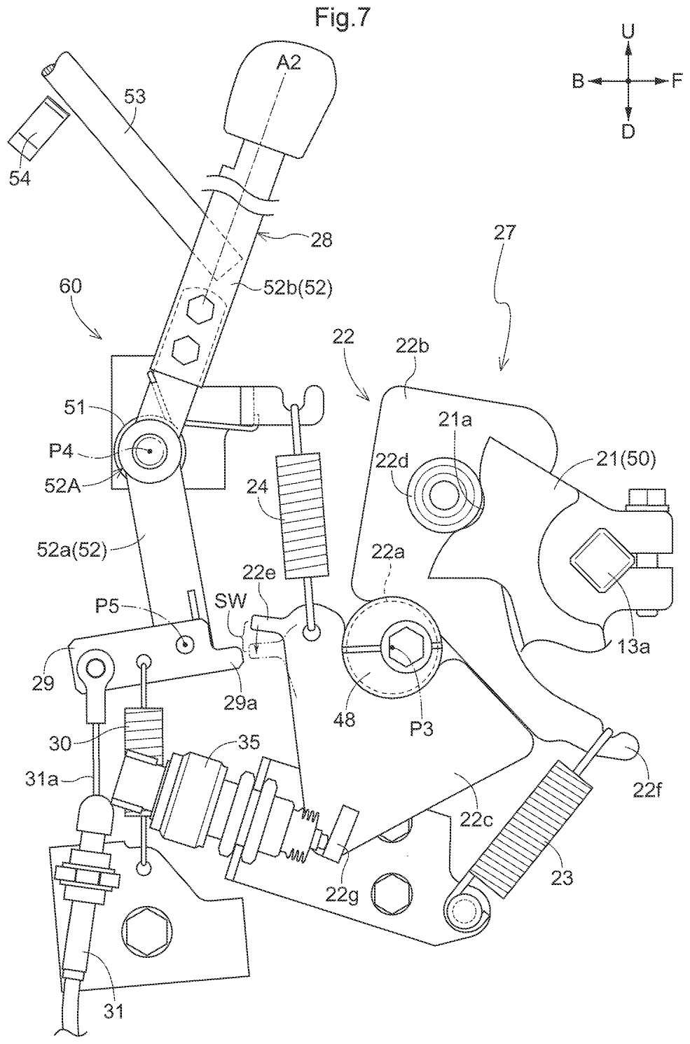

As shown in FIGS. 6 and 7, the interlocked state switching mechanism 60 includes a switch lever 28 located below the driver's seat 10 and an accelerator interlocking member 29 configured to be operated by the switch lever 28. In this example embodiment, the lower member 22c of the operator 22 functions as a speed change interlocking member that is interlocked with the speed change operation mechanism 50 and is included in the interlocked state switching mechanism 60.

The lower member 22c includes a pressing section 22e extending rearward. The pressing section 22e extends from a point that is in the lower member 22c and is behind the swing shaft 48 toward the accelerator interlocking member 29. In response to the speed change operation mechanism 50 changing the shifting state of the continuously variable transmission 13 to the high speed side, the pressing section 22e swings counterclockwise as one piece with the operator 22 and the lower member 22c about the axis P3.

The accelerator interlocking member 29 is attached to so as to be swingable about an axis P5 that is along the left-right direction. The accelerator interlocking member 29 includes a pressed section 29a extending forward. The pressed section 29a extends from the front portion of the accelerator interlocking member 29 toward the lower member 22c.

A wire 31 is included as an accelerator operating mechanism configured to operate the accelerator unit 42 of the engine 4. An inner 31a of the wire 31 is connected to the rear portion of the accelerator interlocking member 29. This configuration allows the accelerator interlocking member 29 to be interlocked with the wire 31 that is an accelerator operating mechanism.

A spring 30 extends between the rear portion of the accelerator interlocking member 29 and the lower portion of the right wall of the transmission case 6. The accelerator interlocking member 29 is biased by the spring 30 counterclockwise in FIGS. 6 and 7.

The switch lever 28 is attached to the right side of the front portion of the transmission case 6 so as to be swingable about an axis P4 that is along the left-right direction. A winding spring 51 configured to bias a portion that is in the switch lever 28 and is above the axis P4 clockwise in FIGS. 6 and 7 is around the axis P4. The switch lever 28 is manually operable, and is used to operate the accelerator interlocking member 29 to switch the state between an interlocked state and a non-interlocked state.

The switch lever 28 includes a lever member 52 extending upward from the accelerator interlocking member 29 and a lock member 53 located on the lever member 52.

The middle portion in the longitudinal direction of the lever member 52 includes a bendable section 52A. The bendable section 52A of the lever member 52 is supported so as to be swingable on the right side of the front portion of the transmission case 6.

The lever member 52 includes a first lever member 52a connected to the accelerator interlocking member 29 and a second lever member 52b connected to the upper end of the first lever member 52a. The bendable section 52A is provided on the first lever member 52a. The second lever member 52b is bolted to a portion that is in the first lever member 52a and is above the bendable section 52A.

The accelerator interlocking member 29 in the interlocked state is at the interlocked position shown in FIG. 6. The pressed section 29a of the accelerator interlocking member 29 at the interlocked position is located below the pressing section 22e of the lower member 22c, that is, within a swinging range SW of the pressing section 22e.

As described above, in response to the continuously variable transmission 13 being manually shifted to either the forward side or the reverse side, the operator 22 swings counterclockwise in FIGS. 6 and 7 about the axis P3 of the swing shaft 48. In response to the speed change operation mechanism 50 changing the shifting state of the continuously variable transmission 13 to the high speed side, the pressing section 22e configured to swing as one piece with the operator 22 presses the pressed section 29a downward. That is to say, in response to the continuously variable transmission 13 being manually shifted to either the forward side or the reverse side, the pressing section 22e presses the pressed section 29a in the same direction.

In response to the pressed section 29a being pressed downward, the accelerator interlocking member 29 swings clockwise in FIGS. 6 and 7 about the axis P5, and thus the accelerator interlocking member 29 pulls the inner 31a of the wire 31 (see from FIG. 3 to FIG. 5).

This configuration allows, in response to a manual operation on the switch lever 28, the pressed section 29a to move closer to the pressing section 22e so that the pressed section 29a is within the swinging range SW of the pressing section 22e, resulting in an interlocked state in which the continuously variable transmission 13 and the accelerator unit 42 are interlocked with each other.

An engageable section 54 includes a plate spring and is configured to be engageable with the lock member 53. The engageable section 54 is below the driver's seat 10 (see FIG. 1), and is fixed via an unshown support member to the body frames 3. In response to the lock member 53 being engaged with the engageable section 54, the switch lever 28 and the lever member 52 are kept at a position A1 corresponding to the interlocked state. In response to the switch lever 28 being moved toward the non-interlocked state, the engagement between the lock member 53 and the engageable section 54 is canceled. The switch lever 28 and the lever member 52 are kept at a position A2 (see FIG. 7) corresponding to the non-interlocked state due to the biasing force of the winding spring 51.

The accelerator interlocking member 29 in the non-interlocked state is at the non-interlocked position shown in FIG. 7. In the non-interlocked position, even when the continuously variable transmission 13 is manually shifted to the forward side or the reverse side and the operator 22 swings counterclockwise in FIGS. 6 and 7 about the axis P3 of the swing shaft 48, the pressing section 22e does not come into contact with the pressed section 29a. That is to say, the accelerator unit 42 is not operated even when the continuously variable transmission 13 is operated to the high speed side.

This configuration allows, in response to a manual operation on the switch lever 28, the pressed section 29a and the pressing section 22e to move away from each other so that the pressed section 29a is out of the swinging range SW of the pressing section 22e, resulting in a non-interlocked state in which the continuously variable transmission 13 and the accelerator unit 42 are not interlocked with each other.

### OTHER EXAMPLE EMBODIMENTS

Other example embodiments obtained by modifying the foregoing example embodiments will be described below.

(1) A configuration in which one spring is connected to each of the first connection point s1 and the second connection point s2 has been described as an example in the foregoing example embodiments, but the present invention is not limited to this example embodiment, and a plurality of springs may be connected to each of the first connection point s1 and the second connection point s2.

(2) A configuration in which a spring is connected to each of the upper member 22b and the lower member 22c has been described as an example in the foregoing example embodiments, but the present invention is not limited to this example embodiments, and a plurality of springs may be connected to either the upper member 22b or the lower member 22c.

(3) A configuration in which the line of action of the biasing force of the first spring 23 is not parallel to that of the second spring 24 connected to the second connection point s2 has been described as an example in the foregoing example embodiments, but the present invention is not limited to this example embodiment, and the line of action of the biasing force of the first spring 23 may be parallel to that of the second spring 24.

(4) A configuration in which the second spring 24 extends between the lower member 22c and the transmission case 6 has been described as an example in the foregoing example embodiments, but the present invention is not limited to this example embodiment, and, for example, the second spring 24 may extend between the lower member 22c and a body frame 3.

(5) A configuration in which the free length of the second spring 24 is longer than that of the first spring 23 has been described as an example in the foregoing example embodiments, but the present invention is not limited to this example embodiment, and the free length of the second spring 24 may be shorter than that of the first spring 23, or the first spring 23 and the second spring 24 may have the same free length.

(6) A configuration in which the diameter (the winding diameter) of the first spring 23 is substantially the same as that of the second spring 24 in their free length has been described as an example in the foregoing example embodiments, but the present invention is not limited to this example embodiment, and the first spring 23 and the second spring 24 may include coil springs with different diameters (winding diameters) in their free length.

(7) A configuration in which the spring constant of the second spring 24 is larger than that of the first spring 23 has been described as an example in the foregoing example embodiments, but the present invention is not limited to this example embodiment, and, for example, the spring constant of the second spring 24 may be smaller than that of the first spring 23, or the first spring 23 and the second spring 24 may have the same spring constant.

(8) A configuration in which the neutral biasing mechanism 27 receives a biasing force applied from coil springs has been described as an example in the foregoing example embodiments, but the present invention is not limited to this example embodiment, and, for example, a biasing force may be applied from rubber springs or air springs.

(9) A configuration in which the continuously variable transmission 13 is of a hydrostatic type has been described as an example in the foregoing example embodiments, but the present invention is not limited to this example embodiment, and, for example, a continuously variable transmission of a cone type or a conventional automatic transmission of a gear type may be used instead of the continuously variable transmission 13 of a hydrostatic type.

Note that the configurations disclosed in the above-described example embodiments (including the other example embodiments, the same applies hereinafter) can be applied in combination with the configurations disclosed in the other example embodiments as long as there is no contradiction. Also, the example embodiments disclosed in this specification are illustrative, and the example embodiments of the present invention are not limited thereto, and can be modified as appropriate or desired.

Example embodiments of the present invention can be used in various work vehicles, such as combines, rice transplanters, construction work machines, and hybrid working vehicles, in addition to tractors.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
a continuously variable transmission capable of shifting to a forward side and a reverse side; and
a neutral biasing mechanism configured to bias the continuously variable transmission to a neutral position; wherein
the neutral biasing mechanism includes:
a cam connected to an operating shaft of the continuously variable transmission and provided with a concave cam section;
an operator swingable about an axis of a swing shaft and configured to operate the cam to a neutral orientation corresponding to the neutral position by pressing the cam section; and
a plurality of biasing members configured to bias the operator such that the operator swings in a direction in which the operator presses the cam section; and
some of the plurality of biasing members are connected to a first connection point that is in the operator, and remaining ones of the biasing members are connected to a second connection point that is in the operator and is different from the first connection point.

2. The working vehicle according to claim 1, wherein the first connection point is in a portion on one side in the operator with respect to the swing shaft, and the second connection point is in a portion on another side in the operator with respect to the swing shaft.

3. The working vehicle according to claim 1, wherein a line of action of a biasing force of the biasing members connected to the first connection point is not parallel to that of the biasing members connected to the second connection point.

4. The working vehicle according to claim 1, wherein the operator includes a rotatable roller configured to operate the cam to the neutral orientation corresponding to the neutral position by fitting into the cam section.

5. The working vehicle according to claim 1, wherein a distance from the first connection point to the axis of the swing shaft is different from that from the second connection point to the axis of the swing shaft.

6. The working vehicle according to claim 1, wherein
the biasing members consist of two biasing members;
the operator includes a first operator and a second operator configured to swing as one piece with the first operator; and
the two biasing members include a first biasing member connected to the first operator and a second biasing member connected to the second operator.

7. The working vehicle according to claim 6, wherein
a transmission case is provided behind the continuously variable transmission; and
the second biasing member extends between the second operator and the transmission case.

8. The working vehicle according to claim 6, wherein the first biasing member and the second biasing member include coil springs with respective different lengths.

9. The working vehicle according to claim 6, wherein the first biasing member and the second biasing member include coil springs with respective different diameters.
